(19) United States
(12) Patent Application Publication
(10) Pub. No.: US 2012/0030555 A1
(43) Pub. Date: Feb. 2, 2012

(54) SYSTEM AND METHOD FOR PROVIDING DYNAMIC NORMALIZATION OF TERMINAL SOURCE EXCEL FILES

(76) Inventors: Kevin Scott, Falls Church, VA (US); Janez Narat, Brookeville, MD (US); Joyce Chau, Germantown, MD (US); Maria Klimchak, Germantown, MD (US); Elena Belyaev, Gaithersburg, MD (US); Bruce Duncan, Walkersville, MD (US)

(21) Appl. No.: 13/193,415

(22) Filed: Jul. 28, 2011

Related U.S. Application Data
(60) Provisional application No. 61/369,437, filed on Jul. 30, 2010.

(51) Int. Cl. G06F 17/20

(52) U.S. Cl. 715/212

(57) ABSTRACT

A system and method are disclosed for providing dynamic normalization of terminal source Excel files. Embodiments of the system and method automatically, continually and non-destructively transform terminal source Excel files from formats that are simple to use by end users into a format that is optimized for automated analysis. Embodiments of the system and method enable businesses to efficiently and effectively analyze corporate data stored and/or managed in Microsoft Excel.

### RELATED APPLICATION

This application claims priority to, and the benefit of, U.S. Provisional Application Ser. No. 61/369,437, filed on Jul. 30, 2010, entitled “A System and Method for Providing Dynamic Normalization of Terminal Source Excel Files,” which is herein incorporated by reference in its entirety.

### BACKGROUND

Microsoft's Excel™ software may be one of the most important storage and access mechanisms for corporate data. Important business data is often collected, managed, stored and used in “terminal source” Excel files. “Terminal source” Excel files differ from other Excel files in that they are actually created by an end user versus being derived by an export or ETL (extract, transform, load) process from some other electronic system. Terminal source files may also be called original or first generation sources. These files are typically created by typing or pasting numbers into a worksheet, or by some other manual or primitive process of collection. Terminal source files cannot be easily recreated if lost or damaged, whereas “non-terminal source” Excel files can be recreated by re-running the automated export or ETL process that first created them. Excel-based data sources remain pervasive despite the efforts of many organizations to define and use larger, centralized, safer, controllable, and auditable data repositories. The popularity of Excel in these cases can be attributed to the familiarity of business users with Excel's features and functions, and with the relative ease in which Excel-based data sources can be created and populated.

Terminal source Excel files are easily created and read directly by end users, however, they are typically ill-suited to support comprehensive data analysis since data normalization is generally required. In fact, the same features that make Excel easy to read by end users often inhibit detailed analysis by other software tools.

Excel itself contains support for data normalization. However, the Excel solution for data normalization involves writing Visual Basic code that is specific to the data in a particular spreadsheet. Since this solution requires fluency with the Visual Basic programming language, and may need to be reproduced for each spreadsheet, this solution is only realistically implemented by a computer programmer, and not by an end user.

Microsoft SQL Server Business Intelligence Development Studio contains support for Excel normalization. However, the SQL Server solution is complex because it requires desktop software be installed and it requires a multiple step process including the definition of workflows. As a result, the SQL Server solution is typically a one-time process that must be manually re-executed each time the target Excel file is updated.

### DESCRIPTION OF THE DRAWINGS

The detailed description will refer to the following drawings, wherein like numerals refer to like elements, and wherein:

FIG. 1 illustrates an embodiment of a system for providing dynamic normalization of terminal source Excel files;

FIG. 2 is a flow chart illustrating an embodiment of a method for providing dynamic normalization of terminal source Excel files;

FIG. 3 illustrates an exemplary terminal source Excel file (e.g., spreadsheet or worksheet) containing non-normalized data;

FIG. 4 illustrates some examples of the information obtained by the method of FIG. 2 regarding the non-normalized data;

FIG. 5 shows an embodiment of the graphical user interface (GLTI) used by the method of FIG. 2 to collect the non-normalized data to define the normalization parameters;

FIG. 6 illustrates an exemplary preview screen that displays normalized data;

FIG. 7 illustrates an exemplary normalized Excel file containing normalized data after the normalization process is performed by the method of FIG. 2 on the non-normalized data of FIG. 3; and

FIG. 8 illustrates exemplary hardware components of a computer that may be used in connection with the method for providing dynamic normalization of terminal source Excel files.

### DETAILED DESCRIPTION

A system and method are disclosed for providing dynamic normalization of terminal source Excel files. Embodiments of the system and method automatically, continually and non-destructively transform terminal source Excel files from formats that are simple to use by end users into a format that is optimized for automated analysis. Embodiments of the system and method enable users, e.g., businesses, to efficiently and effectively analyze corporate data stored and/or managed in Microsoft Excel, such as Microsoft Excel 2007.

An Excel file is non-normalized if adding new data to the sheet typically means adding additional columns, without changing the number of rows of the sheet. An Excel file is normalized if adding new data to the sheet typically means adding additional rows, without changing the number of columns or organization of the sheet. Normalization is a process of translating a non-normalized spreadsheet into a normalized spreadsheet.

Dynamic normalization may be configurable by a user, e.g., a business user, without intervention from trained information technology (IT) specialists and without explicit knowledge of relational databases. Embodiments of the system and method may provide a single panel web-based graphical user interface (GUI) through which a user can provide instructions to configure and initiate dynamic normalization on a given terminal source Excel file.

Dynamic normalization may be pre-viewable. Once a dynamic normalization process is configured, the GUI may present a preview screen to allow users to immediately verify that the normalization process is configured correctly.

Dynamic normalization may be continual in that whenever the terminal source Excel file is updated with new data, dynamic normalization may be configured to re-occur automatically, without user intervention, to assure that consuming software tools always operate on the most up-to-date data.

Dynamic normalization may be non-destructive. In other words, the original terminal source Excel file may remain intact and usable for its original intended use.

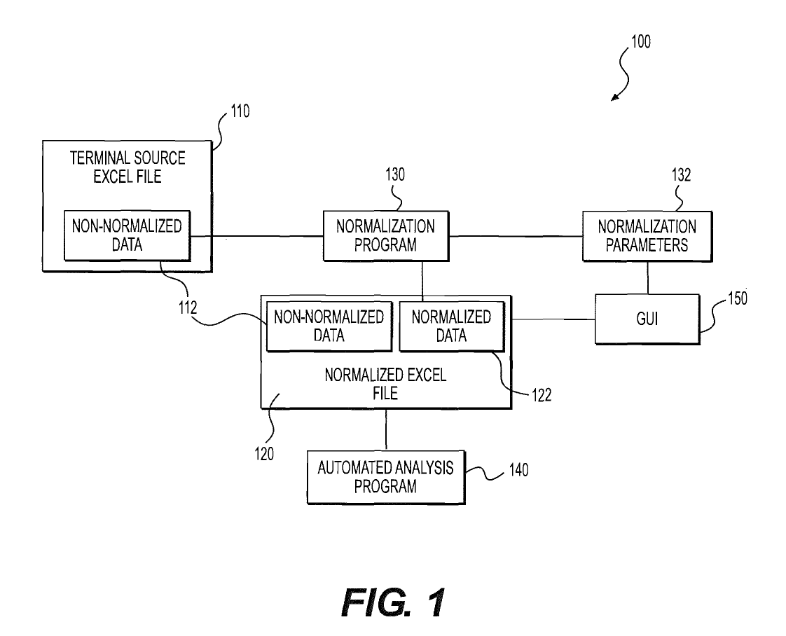

FIG. 1 illustrates an embodiment of a system 100 for providing dynamic normalization of terminal source Excel files. An Excel user typically creates and maintains a terminal source Excel file 110 containing non-normalized data 112. In order for an automated analysis program 140, such as a statistical analysis program or a business forecasting program, to properly analyze Excel data, the data may need to be normalized. An embodiment of the system may execute a normalization program 130 to transform the non-normalized data 112 into normalized data 122. The normalized data 122 may be included, along with the non-normalized data 112, to create a new Excel file 120. This new Excel file, and the included normalized data 122, is suitable for analysis by the external automated analysis program 140. The normalization program 130 may use normalization parameters 132 to complete the normalization process. The normalization parameters 132 may be provided by a user using a graphic user interface (GUI) 150. The normalized Excel file 120 may be presented to the user for preview using the GUI 150.

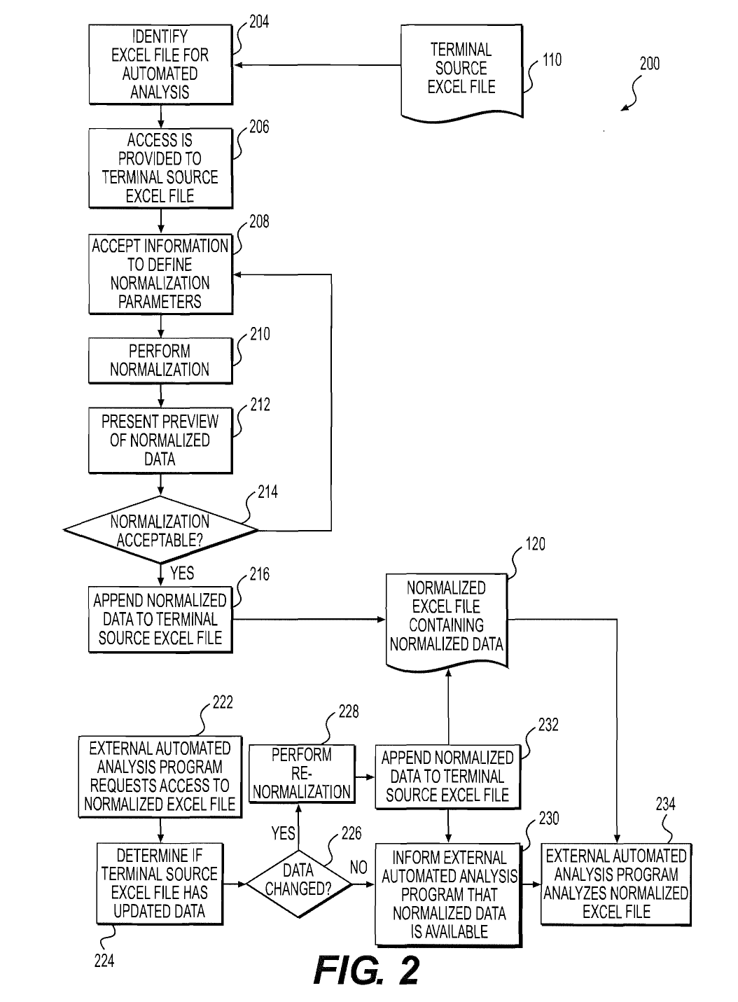

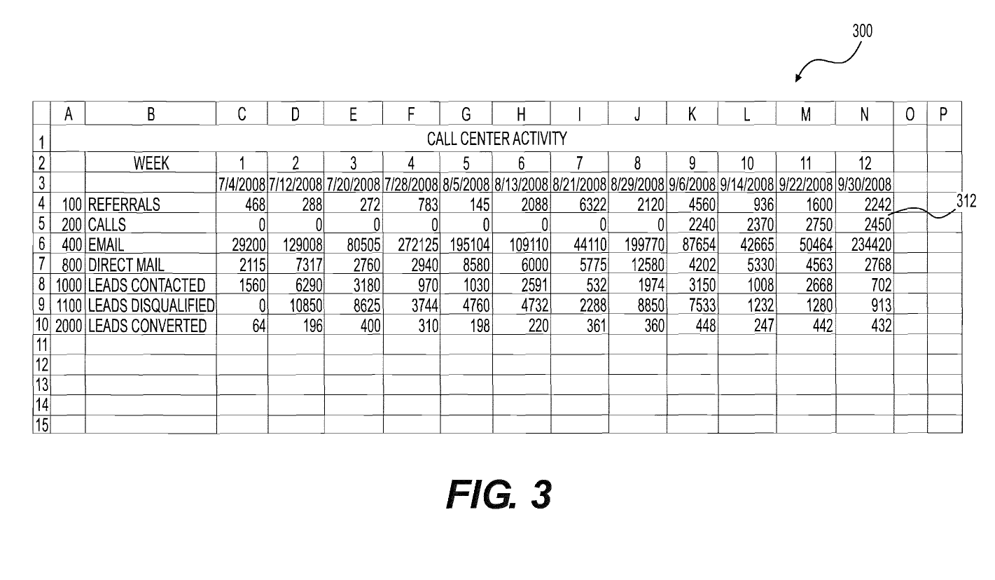

With reference now to FIG. 2, shown is a flow chart illustrating an embodiment of a method 200 for providing dynamic normalization of terminal source Excel files. A terminal source Excel file 110 that is to be analyzed by an automated analysis program 140 may be identified to contain non-normalized data 112 (block 204). FIG. 3 illustrates an exemplary terminal source Excel file 300 (e.g., spreadsheet or worksheet) containing non-normalized data 312. In the example described here, each week a user of the spreadsheet 300 updates data by adding a new column to the spreadsheet 300. Such an update effectively changes the structure of the data table. While the Excel user finds this approach convenient for viewing and maintenance, this format is not well suited for structured analysis.

Referring back to FIG. 2, an embodiment of the method 200 may receive or access the terminal source file 110 (block 206). In an embodiment, users may use the GUI 150 to identify and specify the location of the terminal source Excel file 110. System will access the identified terminal source Excel file 110.

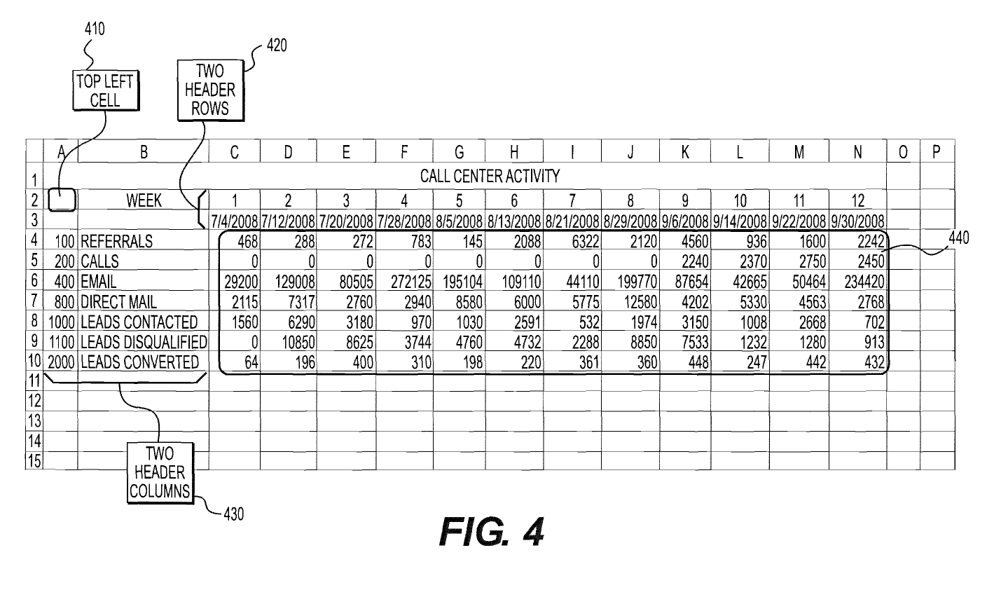

An embodiment of the method 200 may prompt the user for and obtain information regarding the non-normalized data to define a number of normalization parameters 132 (block 208). Using these parameters, an embodiment of the method 200 may automatically transform a spreadsheet containing non-normalized data 112 into a normalized spreadsheet containing normalized data 122, without modifying the original (non-normalized) spreadsheet. With reference now to FIG. 4, shown are some examples of the information obtained (block 208) by the method 200 regarding the non-normalized data. Included in this information may be a series of parameters. Parameter 410 is the top left cell of the cell range in need of normalization. This cell range should include all the data needing to be normalized, as well as all header rows and columns. Parameter 420 is the number of header rows. The header rows are those rows that categorize the data in the cells below them. These rows typically contain information such as the date the data represents. Parameter 430 is the number of header columns. The header columns, like header rows, are cells that help categorize the data in the cells to their right. These cells may include information such as the type and/or sub-type of the data being presented. After providing parameters 410, 420, and 430, a range of cells 440, is thereby designated for normalization. Each cell in this range will be placed in its own row in the normalized output 122 along with the values from the respective header rows and columns as part of an embodiment of method 200.

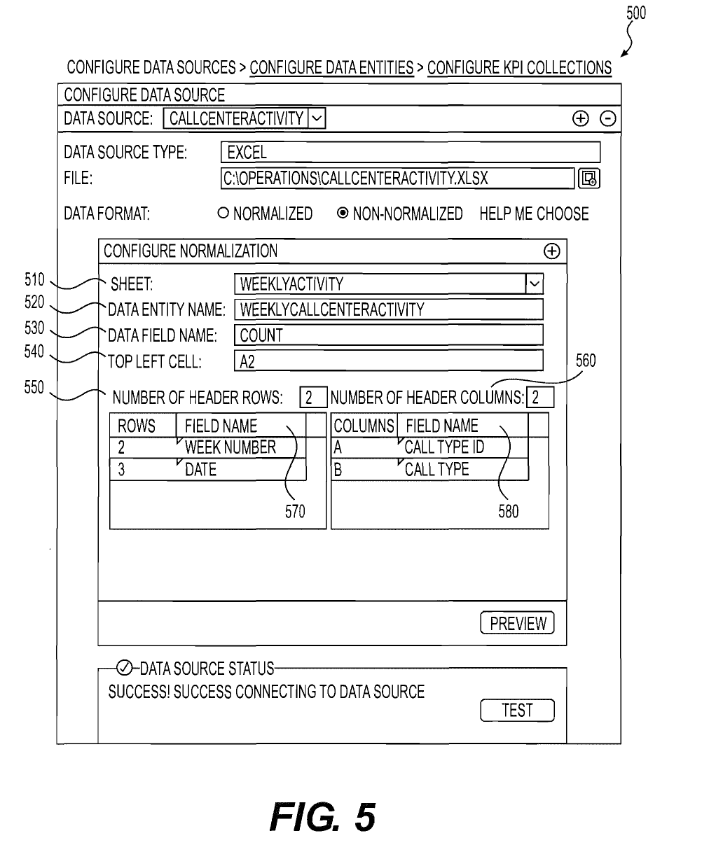

With reference now to FIG. 5, shown is an embodiment of the GUI 500 used by the method 200 to obtain access 206 to the Excel file and define 208 the normalization parameters 132. Examples of the normalization parameters 132, as defined and used by an embodiment of the method 200 for the exemplary Excel file 300 of FIG. 3, are: Sheet 510, Data Entity Name 520, Data Field Name 530, Top Left Cell 540, Number of Header Rows 550, Number of Header Columns 560, Row Field Names 570, and Column Field Names 580.

The normalization parameter Sheet 510 may provide a pull-down menu that specifies the sheet within the terminal source Excel file 110 that contains the non-normalized data 112 that should be normalized. Since the terminal source Excel file 110 may have multiple sheets, this parameter allows the user to specify the correct sheet for normalization.

The normalization parameter Data Entity Name 520 is the name that may be used by external automated analysis programs 140 to reference the normalized version 122 of the non-normalized data 112 in the terminal source Excel file 110.

The normalization parameter Data Field Name 530 is the name of the column in the normalized data that will contain the data originally found in 440. In the example shown in FIGS. 4 and 5, the Data Field Name is called “Count” (see FIG. 5). The cells below Row 3 and to the right of Column B (see FIG. 4) may each be transferred to their own row and placed in the column called “Count.”

The normalization parameter Top Left Cell 540 is the cell in the upper left corner of the area of the worksheet to be normalized. This location (410 shown in FIG. 4) may include all the header rows and all the header columns. In the example shown in FIGS. 4 and 5, the Top Left Cell is “A2.”

The normalization parameter Number of Header Rows 550 is the number of rows in the non-normalized data 112 that contain column heading information. Each of these rows may become a column in the normalized version 122 of the data. In the example shown in FIGS. 4 and 5, two header rows exist (420 shown in FIG. 4): row one contains the week number of the call, and row two contains the date of the call.

The normalization parameter Number of Header Columns 560 is the number of columns in the non-normalized data 112 that contain data that may be transferred unchanged to the normalized version 122 of the data. These columns may be the left-most columns of the non-normalized data 112. In the example shown in FIGS. 4 and 5, two header columns exist (430 shown in FIG. 4): column A contains the call type identifier (ID), and column B contains the call type.

The normalization parameter Row Field Names 570 is the list of names that an embodiment of the method 200 may use for the names of the columns in the normalized data that are created from the header rows in the non-normalized data. These names may be used by automated analysis program 140 for various purposes. For instance, in a business intelligence, dashboarding, or reporting system, these names may appear as menu items that filter or group data in a key performance indicator (KPI) represented as a chart or table. In the example shown in FIG. 5, the two columns are named by an embodiment of the method 200 “Week Number” and “Date.”

The normalization parameter Column Field Names 580 is the list of names that an embodiment of the method 200 may use for the names of the columns in the normalized data that are created from the header columns in the non-normalized data. As described above for the Row Field Names 570 normalization parameter, the names specified as Column Field Names may also be used by automated analysis program 140. As above, in the context of a business intelligence, dashboarding, or reporting system, these names may appear as menu items that filter or group the data in a KPI. In the example shown in FIG. 5, the two header columns are named by an embodiment of the method 200 “Call Type ID” and “Call Type.”

With reference again to FIG. 2, an embodiment of the method 200 may perform an initial normalization of the non-normalized data 112 based on the normalization parameters 132 previously received (block 210), e.g., as described above. For example, method 200 may use the obtained normalization parameters 132 to process the non-normalized data 112 in the identified terminal source Excel file 110 to produce normalized data that may be stored in a normalized file. In embodiments, this normalization process 210 is performed by looping over each cell in the data range identified by the normalization parameters 132. For each cell encountered, a new row in the normalized output is created. Into that new row are placed the values from the header rows and header columns that are in the same row or column as the current data cell. The current data cell value is also placed into that new row. For example, in FIGS. 4 and 5, there are two header rows and two header columns specified. As a result, there would be five columns in the normalized output row. Two output columns in the row would hold the content of the two header rows in the data cell's column. Two output columns in the row would hold the content of the two header columns in the data cell's row. One output column in the row would hold the data cell value itself. The looping proceeds over each row and column in the identified data range until a row completely devoid of values is encountered. At this point the looping ends and the normalized output is saved. When performed as part of the preview process 210, the output may be saved to memory. When performed as part of the approved normalization process 216 or re-normalization process 228, the output may be saved to the normalized Excel file 120 in the appropriate format, such as the XLSX format needed for Microsoft Excel 2007.

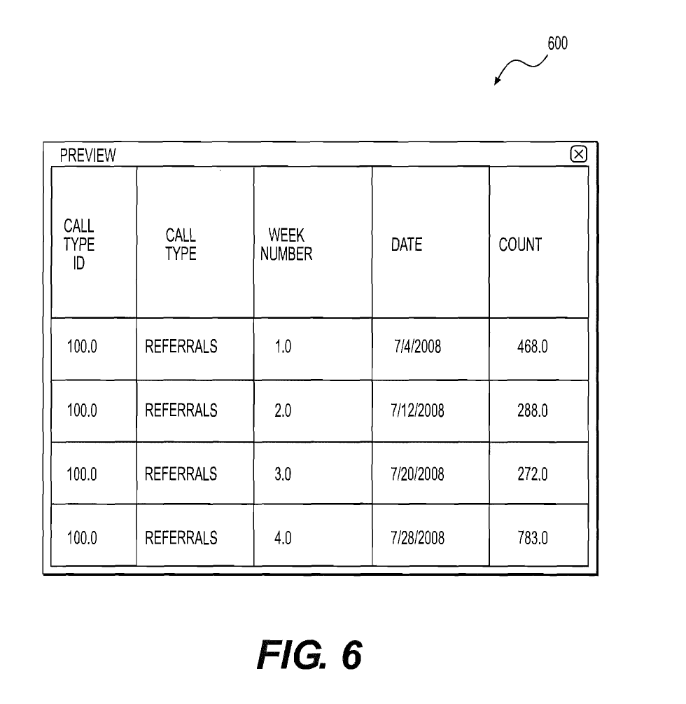

A preview of the normalized data 122 may be presented to the user, e.g., using the GUI 150 (block 212). With reference now to FIG. 6, shown is an exemplary preview screen 600. If the method receives a confirmation that the preview demonstrates the desired normalization (block 214), an embodiment of the method 200 continues. Otherwise, an embodiment of the method 200 returns to block 208 to obtain additional or corrected normalization parameters 132.

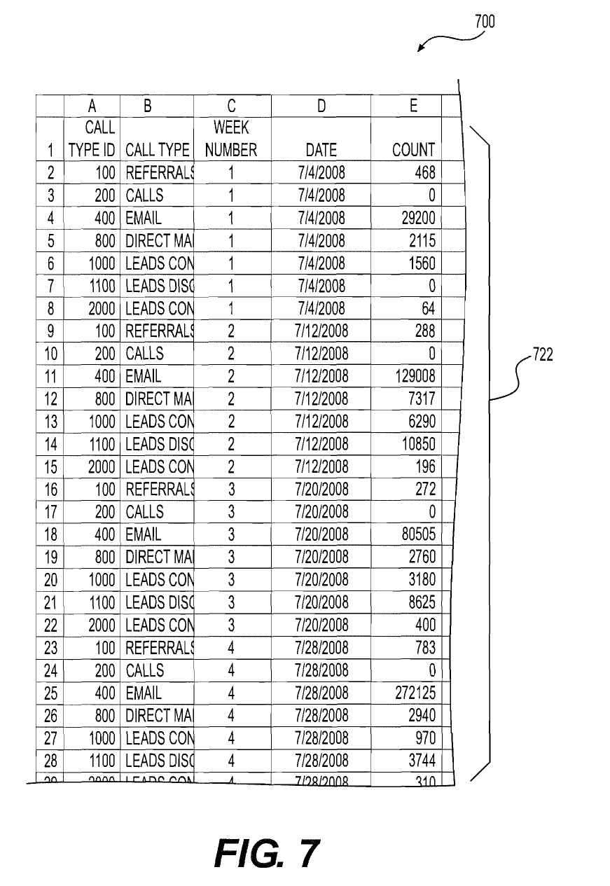

With reference again to FIG. 2, an embodiment of the method 200 may write the normalized data 122 into a new worksheet in a copy of the original Excel file 110 (block 216), e.g., normalized Excel file 120 containing normalized data 122. With reference now to FIG. 7, shown is an exemplary normalized Excel file 700 (e.g., spreadsheet or worksheet) containing normalized data 722 after the normalization process is performed by the method 200 on the non-normalized data 312 of FIG. 3.

The normalized data 722 shown in FIG. 7 may be identical to the non-normalized data 312 of FIG. 3. However, the normalized data 722 is reorganized so that when new data is added to the normalized spreadsheet 700, new rows are added to hold that new data, not new columns. The number of columns remains constant regardless of whether the user adds data for a new week, for example, or introduces a new set of call types. This format supports a variety of complex structured analysis by external automated analysis programs 140.

Referring back to FIG. 2, the external automated analysis program 140 may request access to the normalized Excel file (block 222). An embodiment of the method 200 may automatically determine if the target terminal source Excel file 110 has updated data (block 224). If the non-normalized data 112 has changed (block 226), an embodiment of the method 200 may automatically execute the normalization program 130 to perform re-normalization (block 228), create a copy of the terminal source Excel file 110 (which becomes 120), append the normalized data 122 to this newly created Excel file 120 (block 232), and inform the external automated analysis program 140 that the normalized data 122 is available (block 230). If the non-normalized data 112 has not changed (block 226), an embodiment of the method 200 may inform the external automated analysis program 140 that the normalized data 122 has not changed and is available (block 230). The normalized Excel file 120 containing the normalized data 122 may be provided to the external automated analysis program 140 to be analyzed (block 234).

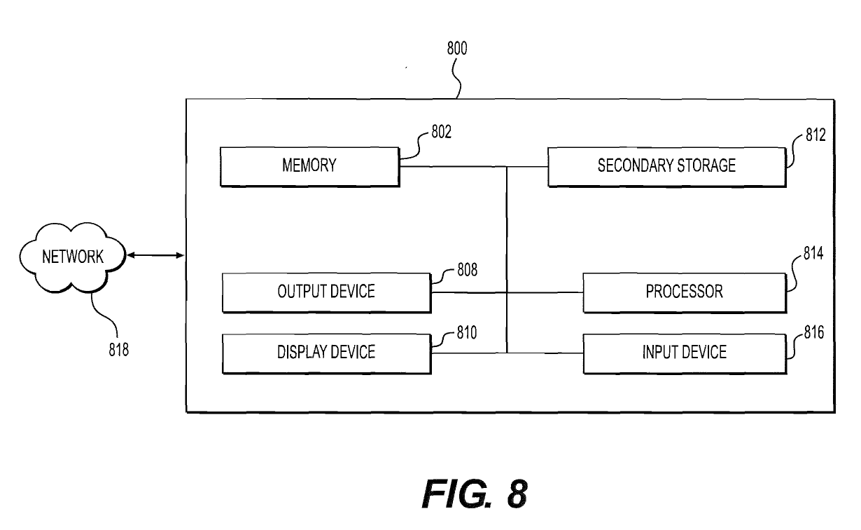

With reference now to FIG. 8, shown is a block diagram illustrating exemplary hardware components for implementing embodiments of system 100 and method 200 for providing dynamic normalization of terminal source Excel files. Server 800, or other computer system similarly configured, may include and execute one or more normalization programs 130 and automated analysis programs 140 to perform functions described herein, including steps of method 200 described above. Likewise, a mobile device which includes some of the same components of computer system 800 may perform steps of method 200 described above. Computer system 800 may connect with network 818, e.g., Internet, or other network, to receive inquires, obtain data, and transmit information and incentives as described above.

Computer system 800 typically includes a memory 802, a secondary storage device 812, and a processor 814. Server 800 may also include a plurality of processors 814 and be configured as a plurality of, e.g., bladed servers, or other known server configurations. Server 800 may also include an input device 816, a display device 810, and an output device 808. Memory 802 may include RAM or similar types of memory, and it may store one or more applications for execution by processor 814. Secondary storage device 812 may include a hard disk drive, floppy disk drive, CD-ROM drive, or other types of non-volatile data storage. Processor 814 executes the application(s), such as normalization program 130 and automated analysis program 140, which are stored in memory 802 or secondary storage 812, or received from the Internet or other network 818. The processing by processor 814 may be implemented in software, such as software modules, for execution by computers or other machines. These applications preferably include instructions executable to perform the functions and methods described above and illustrated in the Figures herein. The applications preferably provide GUIs through which users may view and interact with the application(s), such as normalization program 130 and automated analysis program 140.

Also, as noted, processor 814 may execute one or more software applications in order to provide the functions described in this specification, specifically to execute and perform the steps and functions in the methods described above. Such methods and the processing may be implemented in software, such as software modules, for execution by computers or other machines. The GUIs may be formatted, for example, as web pages in HyperText Markup Language (HTML), Extensible Markup Language (XML) or in any other suitable form for presentation on a display device depending upon applications used by users to interact with the system 100.

Input device 816 may include any device for entering information into computer system 800, such as a touch-screen, keyboard, mouse, cursor-control device, microphone, digital camera, video recorder or camcorder. The input device 816 may be used to enter information into GUIs during performance of the methods described above. Display device 810 may include any type of device for presenting visual information such as, for example, a computer monitor or flat-screen display (or mobile device screen). The display device 810 may display the GUIs and/or output from normalization program 130 and automated analysis program 140. Output device 808 may include any type of device for presenting a hard copy of information, such as a printer, and other types of output devices include speakers or any device for providing information in audio form.

Examples of computer system 800 include dedicated server computers, such as bladed servers, personal computers, laptop computers, notebook computers, palm top computers, network computers, mobile devices, or any processor-controlled device capable of executing a web browser or other type of application for interacting with the system.

Although only one computer system 810 is shown in detail, system 100 may use multiple computer systems or servers as necessary or desired to support the users and may also use back-up or redundant servers to prevent network downtime in the event of a failure of a particular server. In addition, although computer system 800 is depicted with various components, one skilled in the art will appreciate that the server can contain additional or different components. In addition, although aspects of an implementation consistent with the above are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling a computer system, computer system 800, to perform a particular method, such as methods described above.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed is:

1. A method for providing dynamic normalization of terminal source Excel files, the method being implemented by a computer including a processor, the method comprising:
identifying a terminal source Excel file that contains non-normalized data, in which new data is added to the terminal source Excel file by adding new columns;
accepting information regarding the non-normalized data from a user using a graphical user interface (GUI) to define normalization parameters, the normalization parameters including one or more of Sheet, Data Entity Name, Data Field Name, Top Left Cell, Number of Header Rows, Number of Header Columns, Row Field Names, and Column Field Names;
performing normalization, using a normalization program executed by the processor, to transform the non-normalized data in the terminal source Excel file to normalized data; and
appending the normalized data to the terminal source Excel file to create a normalized Excel file containing both the normalized data and the non-normalized data, in which new data is added to the normalized Excel file by adding new rows.

2. The method of claim 1, further comprising allowing the user to specify a location of the terminal source Excel file, using the GUI, to provide access to the terminal source Excel file.

3. The method of claim 1, further comprising presenting a preview of the normalized data to the user, using the GUI.

4. The method of claim 1, further comprising:
automatically determining if the terminal source Excel file has updated data; and
automatically performing re-normalization of the terminal source Excel file when the terminal source Excel file has updated data.

5. The method of claim 1, further comprising receiving a request to access the normalized Excel file by an automated analysis program.

6. The method of claim 1, further comprising informing the automated analysis program that the normalized data is available.

7. The method of claim 1, wherein the normalization parameters include one or more of Sheet, which provides a pull-down menu that specifies a sheet within the terminal source Excel file, wherein the terminal source Excel file has multiple sheets with non-normalized data; Data Entity Name, which is the name used to reference the normalized data; Data Field Name, which is the name of the column in the normalized data that contains the non-header non-normalized data that is being normalized; Top Left Cell, which is the cell in the upper left corner of the area of the terminal source Excel file to be normalized; Number of Header Rows, which is the number of rows in the non-normalized data that contain column heading information, wherein each of the rows becomes a column in the normalized data; Number of Header Columns, which is the number of the left most columns in the non-normalized data that contain data that is transferred unchanged to the normalized data; Row Field Names, which is the list of names that are used for the names of the columns that are created in the normalized data from the header rows in the non-normalized data, wherein the names may appear as menu items that filter or group the normalized data in a KPI; and Column Field Names, which is the list of names that are used for the names of the columns that are created in the normalized data from the header columns in the non-normalized data, wherein the names may appear as menu items that filter or group the normalized data in a KPI.

8. A system for providing dynamic normalization of terminal source Excel files, the system being implemented by a computer including a processor, the system comprising:
a terminal source Excel file that contains non-normalized data, in which new data is added to the terminal source Excel file by adding new columns;
a graphical user interface (GUI) that accepts information regarding the non-normalized data from a user to define normalization parameters, the normalization parameters including one or more of Sheet, Data Entity Name, Data Field Name, Top Left Cell, Number of Header Rows, Number of Header Columns, Row Field Names, and Column Field Names; and
a normalization program that is executed by the processor to perform normalization to transform the non-normalized data to normalized data, wherein the normalized data is appended to the terminal source Excel file to create a normalized Excel file containing both the normalized data and the non-normalized data, in which new data is added to the normalized Excel file by adding new rows.

9. The system of claim 8, wherein the GUI allows the user to specify a location of the terminal source Excel file to provide access to the terminal source Excel file.

10. The system of claim 8, wherein the GUI presents a preview of the normalized data to the user.

11. The system of claim 8, wherein the normalization program automatically determines if the terminal source Excel file has updated data, and automatically performs re-normalization of the terminal source Excel file when the terminal source Excel file has updated data.

12. The system of claim 8, further comprising an automated analysis program that requests access to the normalized Excel file.

13. The system of claim 8, wherein the normalization parameters include one or more of Sheet, which provides a pull-down menu that specifies a sheet within the terminal source Excel file, wherein the terminal source Excel file has multiple sheets with non-normalized data; Data Entity Name, which is the name used to reference the normalized data; Data Field Name, which is the name of the column in the normalized data that contains the non-header non-normalized data that is being normalized; Top Left Cell, which is the cell in the upper left corner of the area of the terminal source Excel file to be normalized; Number of Header Rows, which is the number of rows in the non-normalized data that contain column heading information, wherein each of the rows becomes a column in the normalized data; Number of Header Columns, which is the number of left most columns in the non-normalized data that contain data that is transferred unchanged to the normalized data; Row Field Names, which is a list of names that are used for the names of the columns that are created in the normalized data from the header rows in the non-normalized data, wherein the names may appear as menu items that filter or group the normalized data in a KPI; Column Field Names, which is a list of names that are used for the names of the columns that are created in the normalized data from the header columns in the non-normalized data, wherein the names may appear as menu items that filter or group the normalized data in a KPI.

14. A non-transitory computer readable medium providing instructions for providing dynamic normalization of terminal source Excel files, the instructions comprising:
identifying a terminal source Excel file that contains non-normalized data, in which new data is added to the terminal source Excel file by adding new columns;
accepting information regarding the non-normalized data from a user using a graphical user interface (GUI) to define normalization parameters, the normalization parameters including one or more of Sheet, Data Entity Name, Data Field Name, Top Left Cell, Number of Header Rows, Number of Header Columns, Row Field Names, and Column Field Names;
performing normalization, using a normalization program executed by the processor, to transform the non-normalized data to normalized data;
appending the normalized data to the terminal source Excel file to create a normalized Excel file containing both the normalized data and the non-normalized data, in which new data is added to the normalized Excel file by adding new rows.

15. The computer readable medium of claim 14, further comprising instructions for allowing the user to specify a location of the terminal source Excel file, using the GUI, to provide access to the terminal source Excel file.

16. The computer readable medium of claim 14, further comprising instructions for presenting a preview of the normalized data to the user, using the GUI.

17. The computer readable medium of claim 14, further comprising instructions for:
automatically determining if the terminal source Excel file has updated data; and
automatically performing re-normalization of the terminal source Excel file when the terminal source Excel file has updated data.

18. The computer readable medium of claim 14, further comprising instructions for receiving a request to access the normalized Excel file by an automated analysis program.

19. The computer readable medium of claim 14, further comprising instructions for informing the automated analysis program that the normalized data is available.

20. The computer readable medium of claim 14, wherein the normalization parameters include one or more of Sheet, which provides a pull-down menu that specifies a sheet within the terminal source Excel file, wherein the terminal source Excel file has multiple sheets with non-normalized data; Data Entity Name, which is the name used to reference the normalized data; Data Field Name, which is the name of the column in the normalized data that contains the non-header non-normalized data that is being normalized; Top Left Cell, which is the cell in the upper left corner of the area of the terminal source Excel file to be normalized; Number of Header Rows, which is the number of rows in the non-normalized data that contain column heading information, wherein each of the rows becomes a column in the normalized data; Number of Header Columns, which is the number of left most columns in the non-normalized data that contain data that is transferred unchanged to the normalized data; Row Field. Names, which is the list of names that are used for the names of the columns that are created in the normalized data from the header rows in the non-normalized data, wherein the names may appear as menu items that filter or group the normalized data in a KPI; and Column Field Names, which is the list of names that are used for the names of the columns that are created in the normalized data from the header columns in the non-normalized data, wherein the names may appear as menu items that filter or group the non-normalized data in a KPI.
